(19) United States
(12) Patent Application Publication
(10) Pub. No.: US 2007/0035197 A1
(43) Pub. Date: Feb. 15, 2007

(54) Outer rotor motor

(75) Inventor: Hiroaki Usui, Ueda-shi (JP)

Correspondence Address: BIRCH STEWART KOLASCH & BIRCH, PO BOX 747, FALLS CHURCH, VA, 22040-0747, US

(73) Assignee: Shinano Kenshi Kabushiki Kaisha

(21) Appl. No.: 11/501,863

(22) Filed: Aug. 10, 2006

(30) Foreign Application Priority Data
Aug. 11, 2005 (JP) 2005-232757

(51) Int. Cl. H02K 37/14; H02K 1/12

(52) U.S. Cl. 310/257; 310/49 R

(57) ABSTRACT

An outer rotor motor is miniaturized, is easier to assemble, and lead ends can be insulated with improved reliability without a drop in motor characteristics. One or a plurality of concave channels provided in the axial direction in a circumferential surface of a housing and one or a plurality of rotation-stopping portions that engage the concave channels are provided in a surface of each coil bobbin that faces the cylinder. Through-holes are provided in the rotation-stopping portions in parallel with the rotor shaft.

### BACKGROUND OF THE INVENTION

1. Field of the Invention

The present invention relates to an outer rotor motor used in an OA appliance such as a copier or a printer, a computer peripheral, an automobile, a conveying apparatus related to FA (Factory Automation), or the like.

2. Related Art

In a motor, a rotor equipped with a permanent magnet provided so as to face magnetic poles of a stator is caused to rotate by switching the direction of the current passed through a plurality of coils provided in stator units. The coils are connected to a motor circuit board to switch the direction of the current. As one example, in the case of a normal brushless motor, the winding direction of the coils on the stator core is set so that the coils are wound parallel to the output shaft (i.e., so that the winding core direction is perpendicular to the axial direction), and lead ends at the winding start and winding end of the coils both extend outward in the axial direction and are connected to the motor circuit board.

On the other hand, a claw pole-type stepping motor includes a stator and a rotor, where the stator is produced by coaxially stacking a plurality of stator units formed so that each coil is sandwiched by stator yokes and the claw poles are engaged together and the rotor is equipped with a permanent magnet with poles formed facing the claw poles formed on the stator yokes. In this claw pole-type stepping motor, the winding direction of the coils on the coil bobbins is perpendicular to the axial direction (and the bobbin winding cores are concentric with the output shaft). The lead ends at the winding start and winding end of each coil extend out from the coil using cutaway parts in outer circumferential portions of the stator yokes in an inner rotor motor (see Patent Document 1), or extend toward an outer circumference of the coil from between pole teeth of the stator yokes in an outer rotor motor, and are connected to the motor circuit board. As described in Patent Document 2, there is also a method that presses terminals for supplying power into the coil bobbin of each coil and carries out a wiring process to connect the lead ends.

A claw pole-type stepping motor is assembled so that the pole centers of stator yokes have a predetermined phase difference in the circumferential direction with the pole centers of adjacent stator yokes. To do so, for example there is a method where convexes and concaves are provided on adjacent stator yokes and the stator yokes are positioned by causing the convexes and concaves to be engaged. Also, as disclosed in Patent Document 1, convex parts formed on the coil bobbins may be fitted into through-holes provided in the stator yokes so that the motor is assembled with a predetermined phase difference formed in the circumferential direction between the pole centers of adjacent stator yokes.

Patent Document 1

Japanese Laid-Open Patent Publication No. 2000-217332

Patent Document 2

Japanese Patent No. 3,013,288

With the outer rotor motor described above, since the rotor diameter is large, there are the advantages that a large torque is obtained and the increase in inertia makes it possible to suppress rotational fluctuations. On the other hand, there are the problems of how to miniaturize the outer rotor motor, to make assembly easier, and to insulate the lead ends that extend from the coils with improved reliability without a drop in motor characteristics.

In particular with a claw-pole type motor, when the motor is miniaturized, there is the risk of the stator yokes becoming magnetically saturated, resulting in a drop in the motor characteristics. There is also the risk of the magnetic attractive force becoming unbalanced due to the shape of the stator yokes, resulting in vibration.

Since the cross-sectional areas of the magnetic paths formed in the stator yokes where a current flows normally become smaller toward the inner circumferential side, magnetic saturation is likely to occur on the inner circumferential side. For example, like the motor disclosed in Patent Document 2, when wiring space is provided on the inner circumferential side of the stator yokes, to provide terminals on the coil bobbins, it is necessary to provide clearance on the inner circumferential side of the stator yokes, resulting in the risk of a drop in the motor characteristics due to magnetic saturation of the yoke portions. Also, when the clearance for the terminals provided in the stator yokes is formed at lopsided positions on the inner circumferential side of the yokes, the attractive force that pulls the rotor toward the center of the output shaft will fluctuate between different positions in the circumferential direction, resulting in the possibility of rotational vibrations and/or rotational fluctuations being caused. Also, to provide through-holes in each bobbin into which the terminals are pressed, it is necessary to reduce the area of the part of each bobbin onto which the coil is wound in the radial direction. This means there is the risk of a drop in the motor characteristics and more specifically a drop in motor efficiency, and in turn an increase in the amount of generated heat due to the increase in current or the increase in the resistance of the coil.

In addition, when assembling an outer rotor-type claw pole motor, the winding direction of the coil on each stator yoke (stator core) is perpendicular to the output shaft. Accordingly, to extend the lead ends at the start of winding and end of winding toward the shaft from between the poles of the stator yoke and connect the lead ends to a motor circuit board, the operation is complex and many processes are required. On the other hand, although there is a method where the coil is fitted in by omitting certain magnetic poles on the stator yoke to produce wiring spaces, there is a drop in motor characteristics due to magnetic imbalances, resulting in the risk of rotational vibration.

With a motor with claw pole-type magnetic poles, to form the stator by stacking a plurality of stator units, it is necessary to produce a predetermined phase difference between the pole centers of the respective units. However, when positioning stator units with respect to the bobbins so that the stator unit is sandwiched by the upper and lower stator yokes, phase errors are likely to accumulate due to the concaves and convexes fitting together, and phase errors are also likely to accumulate when positioning the stator units on one another.

In addition, although it is necessary to electrically insulate the stator yokes and the coils, with a wiring method where coil leads extend from between the magnetic poles and are connected to a motor circuit board, it is necessary to prevent the lead wires from contacting the magnetic poles. In particular, when the motor is miniaturized, the pitch of the gaps between the magnetic poles becomes narrow, making the process that connects the lead ends difficult and the motor more difficult to manufacture.

When terminals are formed on a coil bobbin and wires are soldered onto the motor circuit board, at parts where the lead ends of the coils are connected to the terminals, there is the risk of a drop in connection reliability when connecting to the circuit board and it is necessary to increase the clearance of the stator yokes. As described above, providing clearance at the stator yokes can cause a drop in motor characteristics. In the case of a motor wired on the inner circumferential side, when extending a lead end from the outer circumferential side of the coil toward the inner circumferential side, it is necessary to insulate the coil lead and the stator yoke from one another. When an insulating material is provided and/or a space is provided in the stator yoke, there is a reduction in the volume of the coil or the yoke, and the problems of a drop in motor characteristics and of the insulation having poor reliability.

### SUMMARY OF THE INVENTION

The present invention was conceived to solve the problems described above and it is an object of the present invention to provide an outer rotor motor that is miniaturized, is easier to assemble, and where the lead ends of the coils can be insulated with improved reliability without a drop in motor characteristics.

To achieve the stated object, an outer rotor motor according to the present invention includes: a cylinder concentrically provided on a circumference of an output shaft; a stator in which concentrically n stator units per phase on a circumference of the cylinder are stacked, where n is an integer of one or greater and in each stator unit, a coil wound around a coil bobbin is sandwiched by stator yokes; and a rotor where a permanent magnet with magnetic poles formed facing magnetic poles formed on the stator yoke is supported so as to be rotatable around the output shaft, wherein at least one groove portion is provided in the axial direction in a circumferential surface of the cylinder, at least one rotation-stopping portion that fits into the at least one groove portion is provided on a surface of each coil bobbin that faces the cylinder, and a through-hole is provided in each rotation-stopping portion parallel to the output shaft.

A magnetic material may be used for the cylinder and the cylinder may be laminated with the inner circumferential surfaces of the stator yokes in the radial direction to form magnetic paths.

The groove parts of the cylinder and rotation-stopping portions of the coil bobbins that engage one another may be provided at equal distances from the center of the output shaft and at intervals of equal angles in a circumferential direction.

The through-hole of each rotation-stopping portion provided on the bobbin of each stator unit may be constructed so as to pass through in the axial direction with no gaps.

A slot that passes through to the through-hole may be formed continuously in the axial direction in each rotation-stopping portion of each coil bobbin.

A slit from an inner circumferential side to an outer circumferential side and a housing channel that is adjacent to the slit and houses a coil lead may be formed in a flange portion of each coil bobbin and an extension lead of the housing channel may be provided corresponding to the through-hole of a rotation-stopping portion.

By using the outer rotor motor described above, one or a plurality of groove parts is provided in the axial direction in the circumferential surface of the cylinder concentrically provided on a circumference of an output shaft and at least one rotation-stopping portion that fits into the at least one groove portion is provided in a surface of each coil bobbin that faces the cylinder. By doing so, it is possible to accurately position the pole centers of the stator yokes of the respective stator units centered on the cylinder without reducing the volume of the coils wound around the coil bobbins and without greatly reducing the magnetic paths on the inner circumferential side of the bobbins so that the motor characteristics can be maintained. Also, by using a magnetic material for the cylinder and laminating the cylinder with the inner circumferential surfaces of the stator yokes in the radial direction to form magnetic paths, the cross-sectional area of the magnetic paths on the inner circumferential side of the yokes are increased, thereby making it difficult for magnetic saturation to occur. Accordingly, there is no drop in motor characteristics even if the motor is miniaturized.

Also, by providing the groove parts of the cylinder and rotation-stopping portions of the coil bobbins that engage one another at equal distances from the center of the output shaft and at intervals of equal angles in a circumferential direction, the attraction force that pulls the rotor toward the center in the axial direction is unlikely to become unbalanced at different positions in the circumferential direction, rotational vibrations and rotational fluctuations are unlikely to occur and the rotation can be kept stable.

Since the through-holes are provided in the rotation-stopping portions in parallel to the output shaft, it is possible to use the through-holes for wiring coil leads that extend from the coils, and possible to connect the coil leads to the circuit board without providing a space for wiring or insulating material. In this way, in addition to positioning the bobbins and the stator yokes in the circumferential direction, the rotation-stopping portions make it possible to insulate the coil leads without using a special space or material.

If the through-holes of the rotation-stopping portions provided on the bobbins of the stator units are constructed so as to pass through in the axial direction with no gaps, since a single through-hole covered with insulating material is formed, a wiring operation for coil leads is facilitated and the coil leads are insulated more reliably.

If a slot that passes through to the through-hole is formed continuously in the axial direction in each rotation-stopping portion of each coil bobbin, the slots can be used to pass the coil leads into the through-holes without having to pass the coil leads into the openings in the through-holes, which makes the wiring operation even easier.

If a slit from an inner circumferential side to an outer circumferential side and a housing channel that is adjacent to the slit and houses a coil lead are formed in a flange portion of each coil bobbin and an extension lead for the housing channel is provided corresponding to the through-hole of a rotation-stopping portion, a lead wire that extends from the outer circumferential side of a bobbin can be led toward the inner circumferential side of the bobbin using the housing channel without interfering with the stator yokes. By doing so, the lead end can be highly reliably insulated using only a small space, and since the lead end can be passed through the through-hole of a rotation-stopping portion and connected to the circuit board, the wiring operation also becomes easy.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIG. 1 is a cutaway perspective view of a rotor and stator of a two-phase stepping motor;

FIG. 2 is a perspective view showing stator units;

FIG. 3 is a diagram showing a wiring area of a coil;

FIG. 4 is a partially cutaway perspective view of a coil bobbin;

FIG. 5 is a partial cross-sectional view of the coil bobbin;

FIG. 6 is a perspective view of another example of a coil bobbin;

FIGS. 7A and 7B are diagrams showing the cross-sectional forms of cylinders; and

FIGS. 8A and 8B are diagrams showing winding directions of coils.

### DESCRIPTION OF THE PREFERRED EMBODIMENTS

Preferred embodiments of an outer rotor motor according to the present invention will now be described with reference to the attached drawings. The outer rotor motor according to the present invention is a claw-pole type motor where a plurality of stator units, each of which is formed so that a coil is sandwiched by stator yokes and claw poles engage one another, are coaxially stacked in the stator.

The outer rotor motor will be described using a two-phase stepping motor used for example in an OA appliance, a computer peripheral, an automobile, a conveying apparatus related to FA (Factory Automation), or the like.

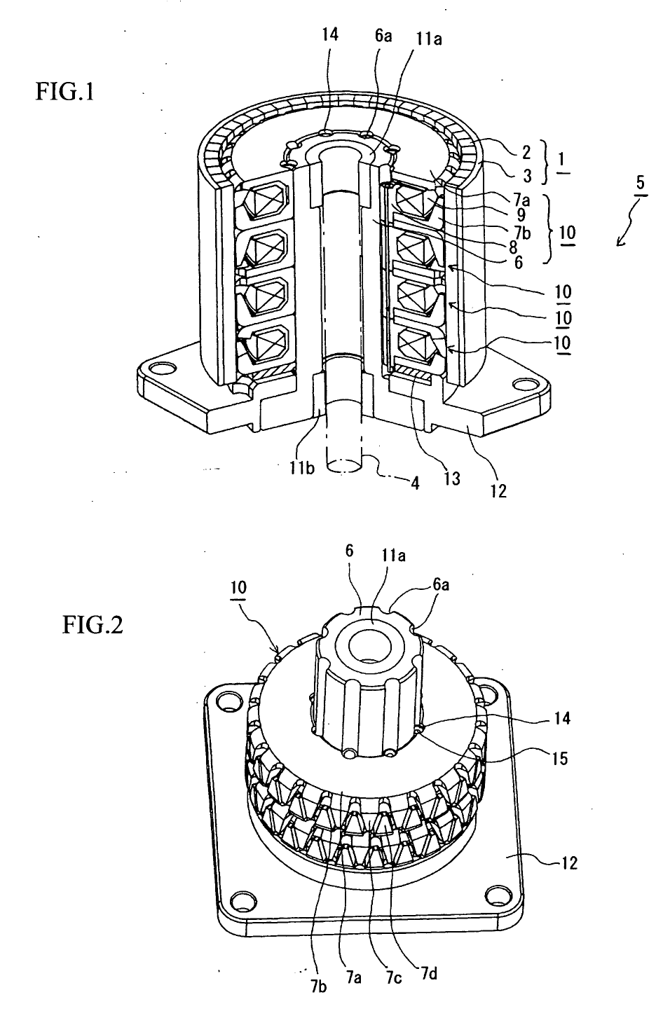

The overall construction of a two-phase stepping motor will be described with reference to FIG. 1. In FIG. 1, a rotor 1 is constructed so that a permanent magnet 2 that has been magnetized with alternating N and S poles in the circumferential direction is provided on an inner circumferential surface of a rotor yoke 3 in the form of a cylinder. The permanent magnet 2 is provided facing magnetic poles (claw poles) of stator yokes, described later. The rotor 1 is supported by being integrally coupled to a rotor shaft (output shaft) 4.

A stator 5 includes a cylinder 6 provided concentrically around the rotor shaft 4 and n stator units 10 per phase (where n is an integer of one or higher: in the present embodiment n=2) that are concentrically attached to a circumference of the cylinder 6. In each stator unit 10, a coil 9 wound around a coil bobbin 8 is sandwiched by stator yokes 7a, 7b. A magnetic material is used for the cylinder 6 and magnetic paths are formed by laminating the cylinder 6 and the inner circumferential surfaces of the stator yokes 7a, 7b in the radial direction. Bearings 11a, 11b that rotatably support the rotor shaft 4 are concentrically attached to the cylinder 6. An mounting plate 12 is attached to the cylinder 6 and a motor circuit board 13 is attached to the mounting plate 12. Lead ends of the coils 9 are led through wiring paths (described later) formed between the cylinder 6 and the coil bobbins 8 and are connected to the motor circuit board 13.

In FIG. 2, each coil 9 on a coil bobbin 8 that has been wound is sandwiched between an upper and lower stator yokes 7a, 7b composed of a magnetic material and the pole centers of the claw poles 7c, 7d that are shaped like the teeth of a comb are formed with a predetermined phase difference in the circumferential direction and are positioned so that the claw poles 7c, 7d are engaged together. The stator units 10 are stacked in the axial direction of the cylinder 6 and the stator units 10 are positioned with a predetermined phase difference between units without the pole centers of the claw poles 7c, 7d being positionally displaced in the circumferential direction.

One or a plurality of groove parts is provided along the axial direction in the circumferential surface of the cylinder 6. In the present embodiment, concave channels 6a with the same depth are formed in the axial direction at positions at intervals of equal angles in the circumferential direction. Note that in place of the concave channels 6a, if there is sufficient room for the wiring space, as shown in FIG. 7B, a chamfered portion 6b may be provided at one or a plurality of positions. Although a magnetic material is used for the cylinder 6, so long as magnetic paths can be formed on the inner circumferential side of the yokes, a non-magnetic material may be used instead.

Also, one or a plurality of rotation-stopping portions 14 that engage the groove parts are provided in the surfaces of the coil bobbins 8 that face the cylinder 6. In each rotation-stopping portion 14, a through-hole 15 is provided parallel to the rotor shaft 4. The through-holes 15 are used as wiring paths for connecting lead wires that extend from the outer circumferential surface of the coils 9 to the motor circuit board 13.

On the coil bobbin 8 shown in FIG. 8A, the coil 9 is wound in a direction perpendicular to the rotor shaft 4 (i.e., the bobbin winding core is concentric with the output shaft). The lead ends at the start of winding and end of winding of each coil are led to the inner circumferential side of each coil bobbin 8 and are connected to the motor circuit board 13 (see FIG. 1). Note that if the stator yokes have magnetic poles that protrude radially outward, as shown in FIG. 8B the coils 9 are wound parallel to the output shaft (i.e., each coil 9 is wound so that the winding core direction is perpendicular to the axial direction) and the lead ends at the start of winding and end of winding of the coil are led in the axial direction and connected to the motor circuit board 13 (see FIG. 1).

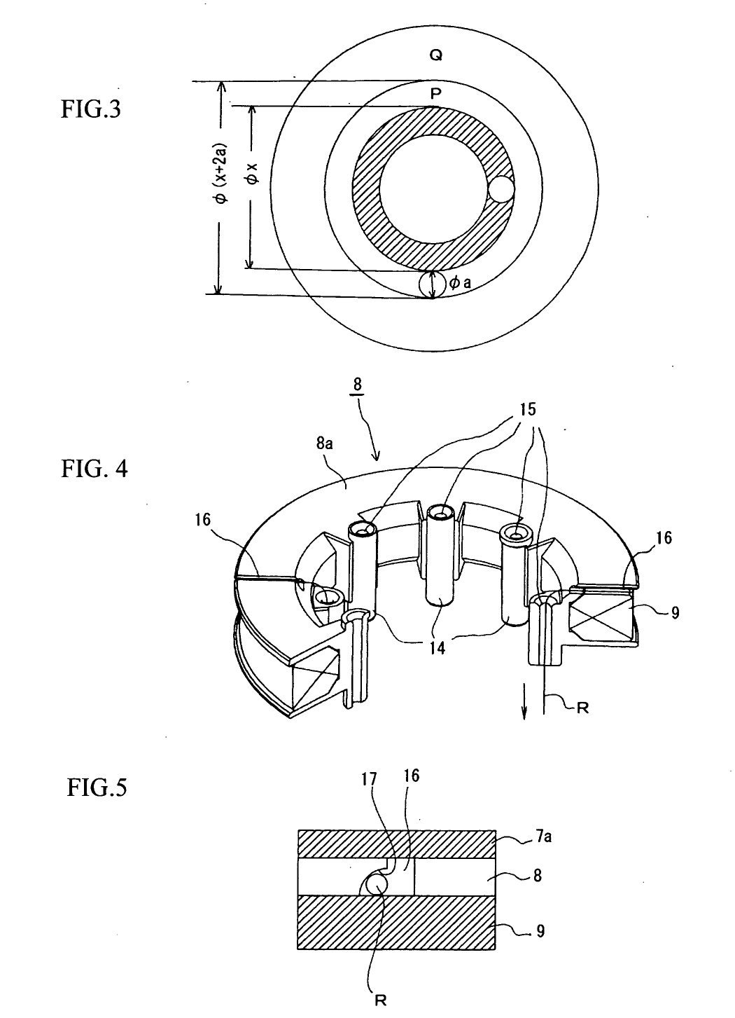

In FIG. 2, the concave channels 6a of the cylinder 6 and the rotation-stopping portions 14 of the coil bobbins 8 that fit together are provided at intervals of equal angles in the circumferential direction and at equal distances from the center of the rotor shaft 4. Next, the relationship between (i) the wiring spaces produced by the convex/concave engagement of the concave channels 6a of the cylinder 6 and the rotation-stopping portions 14 of the coil bobbins 8 and (ii) the magnetic paths will be described using FIG. 3. If the rotation-stopping portions 14 are not provided, the coils can be wired in an area P that is outside a diameter φx of the outer circumference of the cylinder 6 or the inner circumference of the coil bobbin 8. If a through-hole 15 for wiring with a diameter (pa is provided in an area P outside the diameter φx, the range in which the coils can be wound is the area Q outside a diameter of φ(x+2a). On the other hand, if at least one rotation-stopping portion 14 is provided on the inner circumferential sides of the coil bobbins 8 and through-hole(s) 15 with a diameter φa for wiring purposes is/are provided, it is possible to wind the coil in an area P outside the diameter φx in the same way as when the through-hole(s) 15 are not provided. If the cross-sectional area of the rotation-stopping portion(s) 14 is sufficiently small compared to the cross-sectional area of the magnetic material on the inner circumferential side of the stator yokes 7a, 7b including the cylinder 6, it is believed that the effect on the motor characteristics of the partial reduction in the magnetic paths will be small (see the shaded part in FIG. 3).

In this way, by fitting together the concave channels 6a and the rotation-stopping portions 14, the stator units 10 are positioned with respect to the cylinder 6 with a predetermined phase difference between the pole centers of the claw poles 7c, 7d around the circumference and wiring paths for lead wires that extend from the coils 9 can be produced without providing a special space or insulating material. Since the attraction force that pulls the rotor 1 toward the center in the axial direction is unlikely to become unbalanced at different positions in the circumferential direction, rotational vibrations and rotational fluctuations are unlikely to occur and the rotation can be kept stable.

It is preferable for the through-holes 15 of the rotation-stopping portions 14 provided in the coil bobbin 8 of each stator unit 10 to be constructed so as to pass through in the axial direction with no gaps since the wire leads can be insulated with high reliability and the operation that inserts the wires becomes easier.

In FIG. 4, the rotation-stopping portions 14 are provided on the inner circumferential surface of a coil bobbin 8 at positions that are at intervals of an equal angle in the circumferential direction and face the concave channels 6a of the cylinder 6. Slits 16 are also formed in the radial direction in a flange portion 8a of the coil bobbin 8. Housing channels 17 for housing the coil leads R are formed next to these slits 16. Extension leads from the housing channels 17 are provided corresponding to through-holes 15 of the rotation-stopping portions 14. One example of the form of a housing channel 17 is shown in FIG. 5. A concave surface portion is formed in part of an opposite surface to the slit 16 that is formed by cutting away the flange portion 8a in the radial direction, with the concave surface portion forming the housing channel 17 that receives a lead wire R.

A lead wire R that extends from the outer circumferential side of the coil bobbin 8 can be led toward the inner circumferential side of the coil bobbin 8 using the housing channel 17 without interfering with the stator yokes 7a, 7b. By doing so, the lead wire R can be highly reliably insulated using only a small space, and since the lead end can be passed through the through-hole 15 of a rotation-stopping portion 14 and connected to the motor circuit board 13, the wiring operation also becomes easy.

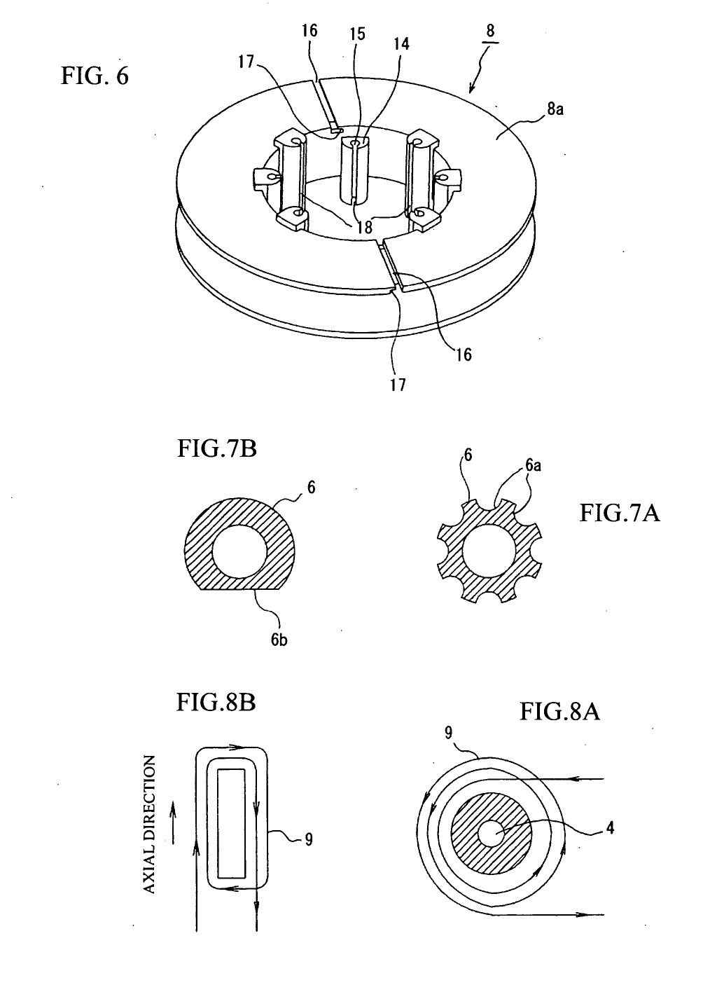

Note that in FIG. 6, slots 18 that pass through to the through-holes 15 may be continuously formed in the axial direction in the rotation-stopping portions 14 of the coil bobbin 8. In this case, the slots 18 can be used to pass the coil leads, which extend from the outer circumferential side of the coil via the housing channels 17, into the through-holes 15 without having to pass the wires into the openings in the through-holes 15, which makes the wiring operation even easier.

Although a claw pole-type two-phase stepping motor has been described as an example in the embodiment described above, the present invention can also be applied to a brushless motor with a sensor circuit board equipped with a sensor that detects the pole positions of the permanent magnet 2 of the rotor 1.

In addition, the stator yokes are not limited to claw pole-type stator yokes, and the present invention can be applied to a motor where a laminated core-type yoke is used to dispose the pole centers with a predetermined phase difference around the circumference.

The present invention is not limited to a two-phase stepping (brushless) motor and a variety of other modifications are possible. For example, it is possible to provide a multiple-phase stepping (brushless) motor with three, four, . . . or n phases where the length in the axial direction is increased but low vibration is achieved.

What is claimed is:

1. An outer rotor motor comprising:
a cylinder concentrically provided on a circumference of an output shaft;
a stator in which concentrically n stator units per phase on a circumference of the cylinder are stacked, where n is an integer of one or greater and in each stator unit, a coil wound around a coil bobbin is sandwiched by stator yokes; and
a rotor where a permanent magnet with magnetic poles formed facing magnetic poles formed on the stator yoke is supported so as to be rotatable around the output shaft,
wherein at least one groove portion is provided in the axial direction in a circumferential surface of the cylinder, at least one rotation-stopping portion that fits into the at least one groove portion is provided on a surface of each coil bobbin that faces the cylinder, and a through-hole is provided in each rotation-stopping portion parallel to the output shaft.

2. An outer rotor motor according to claim 1,
wherein a magnetic material is used for the cylinder and the cylinder is laminated with the inner circumferential surfaces of the stator yokes in the radial direction to form magnetic paths.

3. An outer rotor motor according to claim 1,
wherein the groove parts of the cylinder and rotation-stopping portions of the coil bobbins that engage one another are provided at equal distances from the center of the output shaft and at intervals of equal angles in a circumferential direction.

4. An outer rotor motor according to claim 1,
wherein the through-holes of the rotation-stopping portions provided on the bobbins of the stator units are constructed so as to pass through in the axial direction with no gaps.

5. An outer rotor motor according to claim 1,
wherein a slot that passes through to the through-hole is formed continuously in the axial direction in each rotation-stopping portion provided on each coil bobbin.

6. An outer rotor motor according to claim 1,
wherein a slit from an inner circumferential side to an outer circumferential side and a housing channel that is adjacent to the slit and houses a coil lead are formed in a flange portion of each coil bobbin and an extension lead for the housing channel is provided corresponding to the through-hole of a rotation-stopping portion.
